(19) United States
(12) Patent Application Publication
(10) Pub. No.: US 2025/0062835 A1
(43) Pub. Date: Feb. 20, 2025

(54) TRANSMISSION LINE PARAMETER ESTIMATION APPARATUS AND TRANSMISSION LINE PARAMETER ESTIMATION METHOD

(71) Applicant: Fujitsu Limited, Kawasaki-shi (JP)

(72) Inventors: Ryu SHINZAKI, Ota (JP); Motohiko ETO, Kawasaki (JP); Kyosuke SONE, Kawasaki (JP); Setsuo YOSHIDA, Inagi (JP); Kazuyuki TAJIMA, Yokosuka (JP); Tomoaki TAKEYAMA, Yokohama (JP); Shoichiro ODA, Fuchu (JP)

(73) Assignee: Fujitsu Limited, Kawasaki-shi (JP)

(21) Appl. No.: 18/795,284

(22) Filed: Aug. 6, 2024

(30) Foreign Application Priority Data
Aug. 16, 2023 (JP) 2023-132487

(51) Int. Cl. H04B 10/61; H04B 10/079

(52) U.S. Cl. CPC H04B 10/6165; H04B 10/07951; H04B 10/07957

(57) ABSTRACT

A transmission line parameter estimation apparatus includes: a storage unit configured to stores in advance a non-linear phase rotation amount distribution obtained by using time waveform data acquired from a receiver, of a first transmission line, and a non-linear phase rotation amount of a second transmission line different from the first transmission line; and a controller configured to refer to data in the storage unit, and obtains a non-linear constant of each span of the second transmission line based on a distribution of the non-linear phase rotation amount.

### CROSS-REFERENCE TO RELATED APPLICATION

This application is based upon and claims the benefit of priority of the prior Japanese Patent Application No. 2023-132487, filed on Aug. 16, 2023, the entire contents of which are incorporated herein by reference.

### FIELD

The embodiments discussed herein are related to a transmission line parameter estimation apparatus and a transmission line parameter estimation method.

### BACKGROUND

For efficient and continuous operation of a large amount of traffic in a network system of a transmission line for transmitting signal light, physical characteristics of the transmission line have to be monitored even after a start of the operation.

As a technology related to the monitoring of the physical characteristics of the transmission line, there is proposed a technology for estimating a power change of the transmission line or a chromatic dispersion amount and a chromatic dispersion slope in each span of the transmission line based on signal data acquired from an optical receiver. For example, another technology is known in which a non-linear constant and a chromatic dispersion value are calculated by propagating four wave mixed light of a CW light source to a non-measurement optical fiber and measuring optical power with an optical spectrum analyzer. There is still another technology in which chromatic dispersion characteristics of an optical fiber line are measured by differentiating a phase difference for each wavelength of signal light received by an optical receiver of a terminal station with respect to a wavelength. There is still another technology in which a chromatic dispersion coefficient of an optical fiber span at a certain wavelength is set as a delay difference per unit wavelength between two signal light beams propagating along a unit length of the optical fiber, the chromatic dispersion coefficient along the span of the optical fiber is assumed to be uniform, and chromatic dispersion is calculated by being divided by a length of the span. There is still another technology in which an optical pulse train signal is transmitted through an optical fiber, a non-linear effect of an optical fiber link is monitored by distributed Fourier transform, and chromatic dispersion is obtained.

Japanese Laid-open Patent Publication No. 2003-166904, Japanese Laid-open Patent Publication No. 2002-357509, U.S. Patent Application Publication No. 2010/0283996, and U.S. Patent Application Publication No. 2017/0019172 are disclosed as related art.

### SUMMARY

According to an aspect of the embodiments, a transmission line parameter estimation apparatus includes: a storage unit configured to stores in advance a non-linear phase rotation amount distribution obtained by using time waveform data acquired from a receiver, of a first transmission line, and a non-linear phase rotation amount of a second transmission line different from the first transmission line; and a controller configured to refer to data in the storage unit, and obtains a non-linear constant of each span of the second transmission line based on a distribution of the non-linear phase rotation amount.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a transmission line parameter estimation apparatus according to an embodiment;

FIG. 2 is a chart illustrating an example of a non-linear phase rotation amount distribution of a transmission line;

FIG. 3 is an explanatory diagram of axis conversion of a non-linear phase rotation amount;

FIGS. 4A and 4B are explanatory diagrams of an estimation result of a fiber type in the existing technology;

FIG. 5 is a diagram illustrating a hardware configuration example of a transmission line parameter estimation apparatus;

FIGS. 6A and 6B are explanatory diagrams of a process of estimating a non-linear constant;

FIG. 7 is a flowchart illustrating an example of the process of estimating the non-linear constant;

FIGS. 8A and 8B are explanatory diagrams of a process of estimating a chromatic dispersion coefficient;

FIG. 9 is a flowchart illustrating an example of the process of estimating the chromatic dispersion coefficient;

FIG. 10A is a diagram illustrating a configuration example of calculating a reference value in advance (part 1);

FIG. 10B is a diagram illustrating the configuration example of calculating the reference value in advance (part 2);

FIG. 11 is a flowchart illustrating an example of a process of calculating the reference value in advance;

FIG. 12 is a chart illustrating the reference value calculated in a simulation and a measurement system;

FIG. 13 are explanatory diagrams of a transmission line model;

FIG. 14 is a flowchart illustrating an example of constructing a transmission line model by using an estimation value of the non-linear constant;

FIG. 15 is a functional block diagram illustrating an application example to fiber type identification;

FIG. 16 is a flowchart illustrating an example of fiber type identification using the estimation value of the non-linear constant;

FIG. 17 is a functional block diagram illustrating another application example to the fiber type identification;

FIG. 18 is a flowchart illustrating an example of a process of the fiber type identification;

FIG. 19 is a chart illustrating a phase rotation amount distribution of an estimation target;

FIG. 20 are explanatory diagrams of estimation of a chromatic dispersion coefficient by using existing power profile estimation;

FIG. 21 is a chart illustrating an example of a fiber specification;

FIG. 22 is a flowchart illustrating an example of specifying a fiber type by using the existing power profile estimation;

FIG. 23A is a chart illustrating an example of a power profile of an optical path based on the existing power profile estimation;

FIG. 23B is a chart illustrating various types of data used to specify the fiber type by using the existing power profile estimation;

FIG. 24 is a functional block diagram illustrating identification of the fiber type by the transmission line parameter estimation apparatus according to the embodiment;

FIG. 25 are charts illustrating various types of data used for the identification of the fiber type; and

FIG. 26 is a flowchart illustrating an example of a process of identifying the fiber type of a plurality of spans according to the embodiment.

### DESCRIPTION OF EMBODIMENTS

For optimum control of the entire optical transmission network including a modulation scheme of an optical transceiver, a non-linear constant of each span is useful information. Meanwhile, at present, only a method for measuring the non-linear constant of the transmission line for each span is proposed, and a technology for obtaining the non-linear constant of each span in a multi-span transmission system at a reception end is not established.

For example, in the multi-span transmission system, there is a demand for a technology in which the reception end estimates the non-linear constant of each span based on a reception signal without adding a new optical component or device such as an optical spectrum analyzer.

According to one aspect, an object of the present disclosure is to easily estimate a non-linear constant of a plurality of spans.

Hereinafter, embodiments of a transmission line parameter estimation apparatus according to the present disclosure will be described in detail with reference to the accompanying drawings.

### Configuration Example of Transmission Line Parameter Estimation Apparatus According to Embodiment

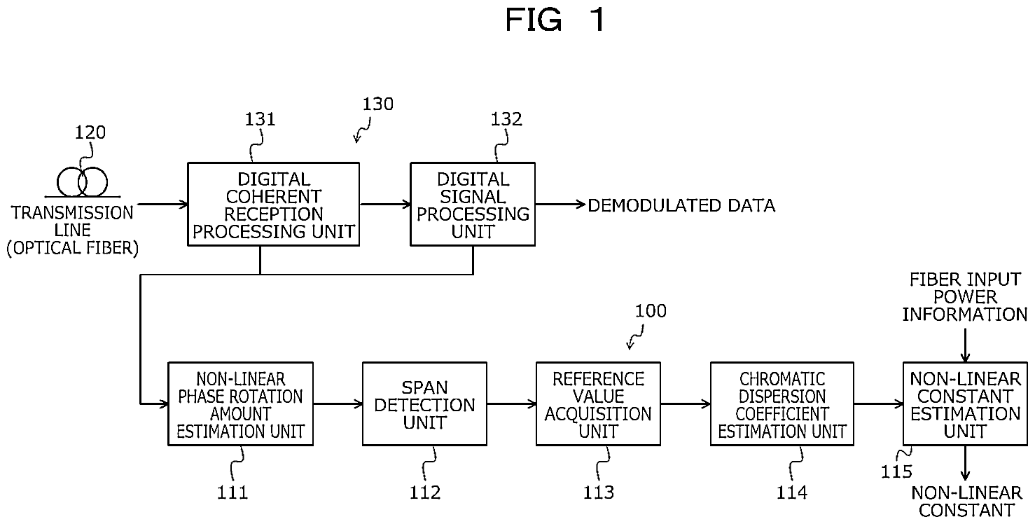

FIG. 1 is a functional block diagram of a transmission line parameter estimation apparatus according to the embodiment. A transmission line parameter estimation apparatus 100 estimates a physical characteristic (transmission line parameter) of a transmission line based on a reception waveform of a digital coherent device. For example, the transmission line parameter estimation apparatus 100 analyzes a change (height or slope) in the phase rotation amount or the dispersion amount at each point, based on distribution information of the non-linear phase rotation amount over the transmission line obtained from a reception signal, and compares the change with information (reference value) acquired under a known condition. Therefore, unknown transmission line parameters, for example, a chromatic dispersion coefficient and a non-linear constant are estimated. For example, the known information may be acquired from design information of the transmission line managed by an administrator of the transmission line, and is acquired by an operation input of the administrator, reference to a design information database, or the like.

For example, the transmission line parameter estimation apparatus 100 is mounted as one function on a receiver (Rx) side of an optical transceiver coupled to a transmission line 120 such as an optical fiber. FIG. 1 illustrates an optical reception unit 130 of a digital coherent optical transceiver. In the optical reception unit 130, a digital coherent reception processing unit 131 performs a reception process on signal light of digital coherent light, and a digital signal processing unit 132 outputs demodulated data obtained by demodulating the reception signal.

The transmission line parameter estimation apparatus 100 acquires data related to transmission line parameter estimation from the digital coherent reception processing unit 131 or the digital signal processing unit 132. The transmission line parameter estimation apparatus 100 has each function of a control unit that estimates a transmission line parameter of the transmission line 120. As each function, the control unit includes a non-linear phase rotation amount estimation unit 111, a span detection unit 112, a reference value acquisition unit 113, a chromatic dispersion coefficient estimation unit 114, and a non-linear constant estimation unit 115.

From signal intensity information of the reception signal collected from the optical reception unit 130, the non-linear phase rotation amount estimation unit 111 estimates a non-linear phase rotation amount distribution at each point of the transmission line 120 as a function of an accumulated chromatic dispersion amount from a transmission end. The signal intensity information is time waveform data having different values at different times.

The span detection unit 112 detects each span correspondence portion for each span in the non-linear phase rotation amount distribution estimated by the non-linear phase rotation amount estimation unit 111. For the transmission line 120, the reference value acquisition unit 113 acquires a reference value of the non-linear phase rotation amount under the known transmission condition, from a storage unit. The reference value includes a non-linear phase rotation amount distribution at each point of a transmission line which is different from the transmission line 120 as an estimation target and has a known transmission line parameter.

Based on the non-linear phase rotation amount distribution estimated by the non-linear phase rotation amount estimation unit 111, the fiber length of each span detected by the span detection unit 112, and the reference value acquired by the reference value acquisition unit 113, the chromatic dispersion coefficient estimation unit 114 calculates an estimation value of a chromatic dispersion coefficient of each span.

Based on the non-linear phase rotation amount distribution, each span correspondence portion, the reference value, the estimation value of the chromatic dispersion coefficient, and the known fiber input power information, the non-linear constant estimation unit 115 calculates an estimation value of a non-linear constant of each span. Hereinafter, each functional unit will be described in detail.

### (Overview of Transmission Line Parameter Estimation)

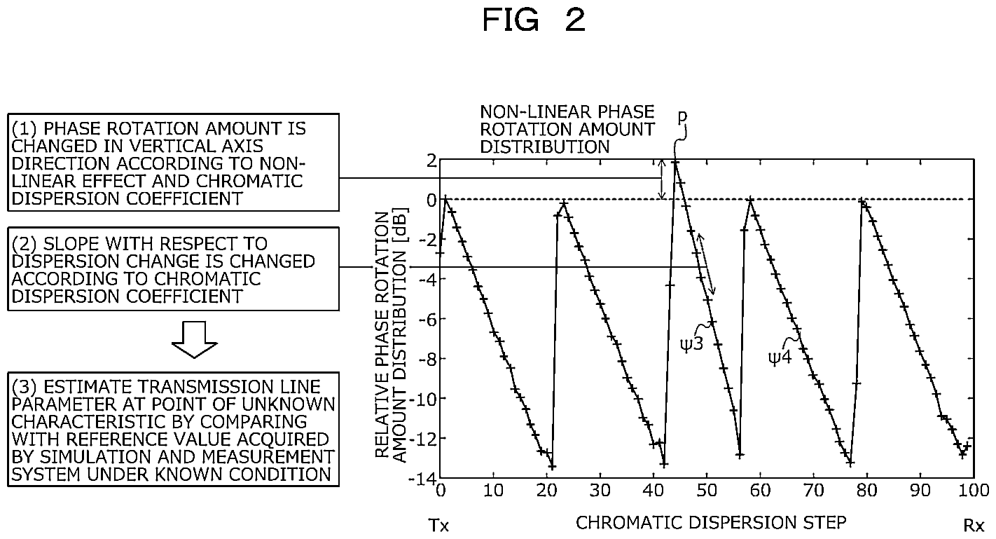

FIG. 2 is a chart illustrating an example of a non-linear phase rotation amount distribution of a transmission line. FIG. 2 has a horizontal axis indicating chromatic dispersion steps and indicating an accumulated value of chromatic dispersion in steps per 1 km for a distance equivalent from a transmitter (Tx) at a transmission end of the signal light to a receiver (Rx) at a reception end of the signal light, and a vertical axis indicating a relative phase rotation amount distribution [dB].

In the example illustrated in FIG. 2, there are five spans between Tx and Rx, and the phase rotation amount distribution in each span has a predetermined height and a predetermined slope corresponding to optical power. (1) A phase rotation amount of each span is changed in a vertical axis direction in accordance with a non-linear effect and a chromatic dispersion coefficient of the transmission line 120. In the example illustrated in FIG. 2, a peak p of a slope ψ3 of the phase rotation amount at a start end of the third span is located higher (+2) in a +direction than a reference (0).

(2) A slope with respect to a dispersion change is changed in accordance with a chromatic dispersion coefficient. In the example illustrated in FIG. 2, the slope ψ3 of the phase rotation amount in the third span is steep with respect to a slope ψ4 of a phase rotation amount in the fourth span.

Based on these (1) and (2), for the phase rotation amount distribution illustrated in FIG. 2, (3) an existing reference value acquired in advance by a simulation or a measurement system under known conditions is compared with a phase rotation amount distribution obtained from a reception signal. Therefore, transmission line parameters (chromatic dispersion coefficient and non-linear constant) at the unknown point are estimated.

According to the embodiment, a transmission line parameter is estimated based on the following expressions.

Expression (1) below represents a non-linear Schrödinger equation, and Expression (2) below represents a non-linear constant. Expression (3) below illustrates self-phase modulation (dispersion axis display).

$$\frac{\partial F}{\partial z} + ( \frac{α}{2} + \frac{i}{2} β \frac{{\partial }^{2}}{\partial {t}^{2}} ) F = i γ {\vert F \vert}^{2} F \qquad ( 1 )$$

$$γ ∝ \frac{ω {n}_{2}}{{A}_{eff}} \qquad ( 2 )$$

$$F ( t ) ↦ F ( t ) \times exp ( i γ {\vert F ( t ) \vert}^{2} L )$$

$$i γ {\vert F ( t ) \vert}^{2} L ( z ) ∝ i \times {\underbrace{ω \times \frac{{n}_{2}}{{A}_{eff}} \times {\vert F ( t ) \vert}^{2} \times \frac{1}{D ( z )}}}_{non - linear phase rotation amount φ} \qquad ( 3 )$$

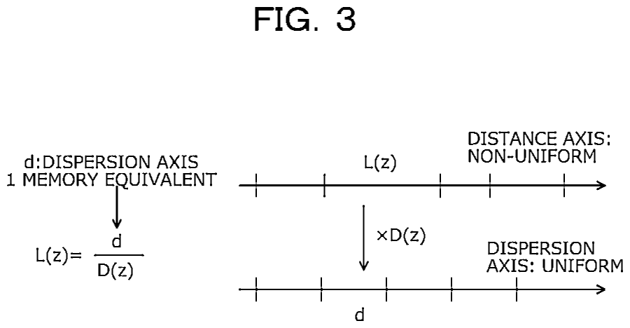

FIG. 3 is an explanatory diagram of axis conversion of a non-linear phase rotation amount. D(z) in Expression (3) above corresponds to a chromatic dispersion coefficient. A distance axis L (z)=d/D(z) is set and d is a dispersion axis 1 memory equivalent, and the distance axis L (z) having non-uniform axial intervals is converted into the uniform dispersion axis d by calculation of ×D(z).

According to the embodiment, a change in slope ψ of the non-linear phase rotation amount by the dispersion axis display is detected based on Expression (4) below. A ratio of the chromatic dispersion coefficient is obtained based on the slope ψ of the non-linear phase rotation amount.

$$\frac{{ψ}_{2}}{{ψ}_{1}} = {( \frac{{D}_{2}}{{D}_{1}} )}^{- 1} \qquad ( 4 )$$

A change in the phase rotation amount due to the self-phase modulation in the non-linear phase rotation amount by the dispersion axis display (frequency ω is assumed to be unchanged) is calculated based on Expression (5) below. φ is a phase rotation amount, K is a non-linear constant, D is a chromatic dispersion coefficient, and P is fiber input power. Each of φ₁, K₁, D₁, and P₁ is a reference value, and is acquired from a simulation and a measurement system under known conditions. Each of φ₂, K₂, D₂, and P₂ is each value of a transmission line as an estimation target, and a calculation method will be described below. The fiber input power P₂ is acquired from monitor information. 10 log φ₂/φ₀−10 log φ₁/φ₀ indicates a change in a height direction, and K₂/K₁ is proportional to a non-linear constant. D₂/D₁ is a ratio of a chromatic dispersion coefficient, and P₂/P₁ is a ratio of power.

$$10 log \frac{{ϕ}_{2}}{{ϕ}_{0}} - 10 log \frac{{ϕ}_{1}}{{ϕ}_{0}} = 10 ( {log}_{2} \frac{{κ}_{2}}{{κ}_{1}} - log \frac{{D}_{2}}{{D}_{1}} + log \frac{{P}_{2}}{{P}_{1}} ) \qquad ( 5 )$$

### (Problem of Existing Technology)

Problems of the existing technology will be described. An example will be described in which a fiber type of each span of a transmission line is estimated based on an estimated non-linear constant. According to the existing technology, in a case where the fiber type may not be determined only by a chromatic dispersion coefficient, it is desirable to obtain a dispersion slope by performing analysis on a plurality of wavelength paths of the same route. For this reason, in the existing technology, 1. a calculation cost for the number of wavelengths is desirable, and 2. data of a plurality of wavelengths is desirable and the existing technology is limited to a case where the data of the plurality of wavelengths may be acquired.

Meanwhile, in the embodiment, a non-linear constant may be estimated from one wavelength path. By narrowing down the fiber types based on the estimated non-linear constant, it is not desirable to obtain a dispersion slope, and the problem of the existing technology described above may be solved. According to the embodiment, it is possible to estimate the fiber type in each span of the transmission line with one wavelength, reduce the number of wavelengths, and reduce the calculation cost. According to the embodiment, for example, it is possible to improve efficiency of estimation of the type of installation fibers in each span of the transmission line. It is possible to reduce an influence of a performance deterioration such as a decrease in SNR margin due to incorrect coupling of fibers.

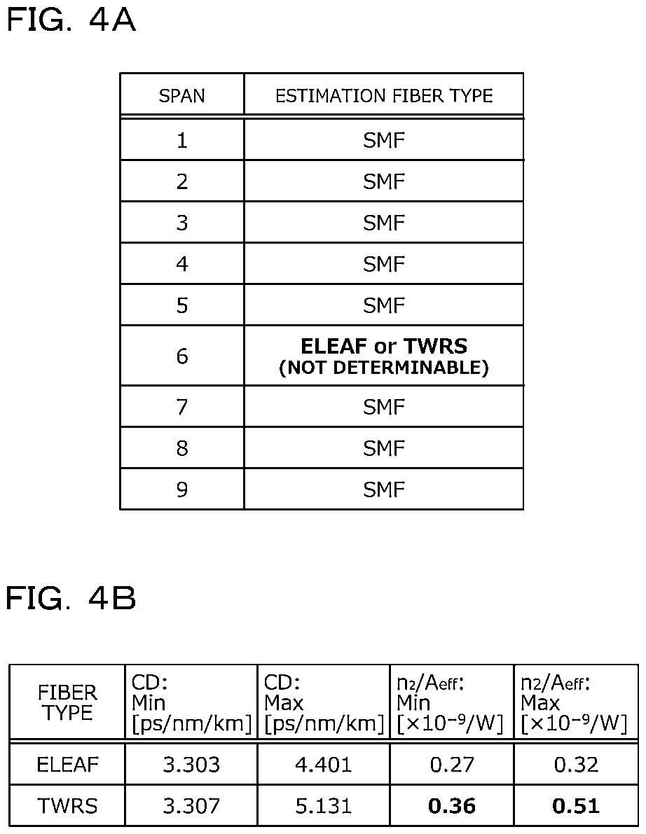

FIGS. 4A and 4B are explanatory diagrams of an estimation result of a fiber type in the existing technology. FIG. 4A illustrates an estimation fiber type for each span of a transmission line. FIG. 4B is a fiber specification table illustrating a minimum value and a maximum value of a chromatic dispersion coefficient (CD) and a non-linear constant (n₂/A_{eff}).

Only with the chromatic dispersion coefficient estimated by the existing technology, it is not possible to determine whether the fiber type of the sixth span in FIG. 4A is ELEAF or TWRS. ELEAF is an abbreviation for Enhanced Large Effective Area Fiber, and TWRS is an abbreviation for TrueWave Reduced Slope.

Meanwhile, according to the embodiment, by estimating the non-linear constant of the sixth span and comparing the estimated non-linear constant with a threshold value (for example, 0.34) of the non-linear constant, it is possible to perform estimation for distinguishing whether the estimated non-linear constant is ELEAF or TWRS.

A non-linear constant range may be calculated based on each of the following technical documents. As a specification sheet of the fiber type, Technical Documents 1 and 2 described below are disclosed.

Technical Document 1: “Corning (registered trademark) LEAF (registered trademark) Optical Fiber Product Information”, [online], SEARCH DATE Jun. 15, 2023, URL:https://www.corning.com/media/worldwide/coc/documents/Fiber/product-information-sheets/PI-1107-AEN.pdf, Corning Incorporated.

Technical Document 2: “TrueWave (registered trademark) RS Optical Fiber”, [online], SEARCH DATE Jun. 15, 2023, URL:https://fiber-optic-catalog.ofsoptics.com/documents/pdf/TrueWaveRSLWP-120-web.pdf, OFS Fitel, LLC.

A Mean Field Diameter (MFD) is checked from a specification sheet of Technical Documents 1 and 2, and ELEAF (0.4 μm) and TWRS (0.6 μm) are used as errors of the MFD.

A relationship between MFD and A_{eff} is obtained from calculation expressions of p39 (II-3) and (II-4) in Technical Document 3.

Technical Document 3: “SERIES G: TRANSMISSION SYSTEMS AND MEDIA, DIGITAL SYSTEMS AND NETWORKS, Transmission media and optical systems characteristics-Optical fibre cables”, SEARCH DATE Jun. 15, 2023, URL:https://www.itu.int/rec/T-REC-G.650.2-201508-I/en, G650.2 (08/2015), ITU-T.

A relationship between A_{eff} and n₂ is obtained from Expression (2) of Technical Document 4, and a non-linear constant (n₂/A_{eff}) is calculated.

Technical Document 4: “Nonlinear empirical equations of (n₂/A_{eff}) and n2 for various Ge-doped single mode optical fibers”, [online], SEARCH DATE Jun. 15, 2023, URL:https://ieeexplore.ieee.org/stamp/stamp.jsp?tp=&arnumber=4610335, 07-10 Jul. 2008, OECC/ACOFT 2008-Joint Conference of the Opto-Electronics and Communications Conference and the Australian Conference on Optical Fibre Technology, IEEE.

### (Hardware Configuration Example of Transmission Line Parameter Estimation Apparatus)

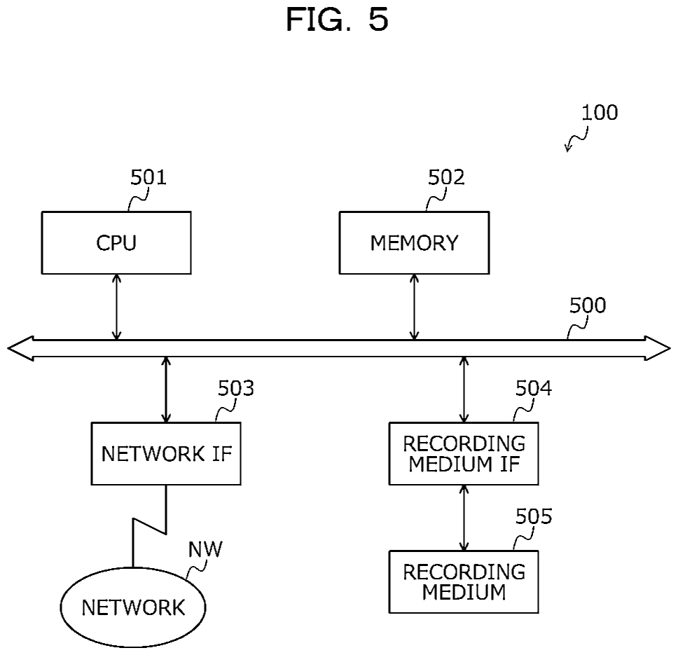

FIG. 5 is a diagram illustrating a hardware configuration example of a transmission line parameter estimation apparatus. For example, the transmission line parameter estimation apparatus 100 may be configured with general-purpose hardware illustrated in FIG. 5.

For example, the transmission line parameter estimation apparatus 100 includes a processor 501 such as a central processing unit (CPU), a memory 502, a network IF 503, a recording medium IF 504, and a recording medium 505. The respective components are coupled to each other by a bus 500.

The processor 501 is a control unit that controls the transmission line parameter estimation apparatus 100. The processor 501 may include a plurality of cores. The memory 502 includes, for example, a read-only memory (ROM), a random-access memory (RAM), a flash ROM, and the like. For example, the flash ROM stores a control program, the ROM stores an application program, and the RAM is used as a work area of the processor 501. The program stored in the memory 502 causes the processor 501 to execute a coded process by being loaded into the processor 501.

The network IF 503 serves as an interface between a network NW and the transmission line parameter estimation apparatus 100, and controls an input and an output of information to and from an outside.

According to the control of the processor 501, the recording medium IF 504 controls read and write of data from and to the recording medium 505. The recording medium 505 stores the data written under the control of the recording medium IF 504.

In addition to the components described above, for example, an input device, a display, and the like may be coupled to the transmission line parameter estimation apparatus 100 via an IF.

By executing a program, the processor 501 illustrated in FIG. 5 may realize the functions of the transmission line parameter estimation apparatus 100 illustrated in FIG. 1. By using the memory 502 and the recording medium 505 illustrated in FIG. 5, it is possible to realize the function of the storage unit that stores the reference value described above.

A hardware configuration of the transmission line parameter estimation apparatus 100 illustrated in FIG. 5 may serve as a function of a control unit of an optical transceiver including the transmission line parameter estimation apparatus 100. In this case, with the hardware configuration illustrated in FIG. 5, in addition to the function related to the optical transmission and the reception process of the optical reception unit 130 or the entire optical transceiver including the optical reception unit 130, the function related to the transmission line parameter estimation by the transmission line parameter estimation apparatus 100 according to the embodiment is realized.

Next, details of each function of the transmission line parameter estimation apparatus 100 according to the embodiment will be described.

### (Estimation of Non-linear Constant)

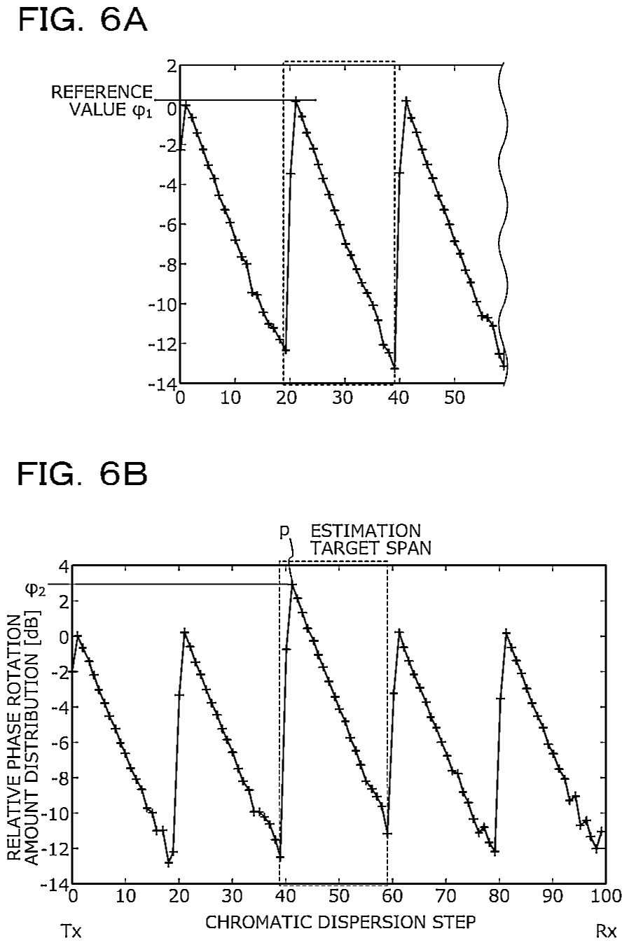

FIGS. 6A and 6B are explanatory diagrams of a process of estimating a non-linear constant. A process example of the transmission line parameter estimation apparatus 100 (mainly, the non-linear constant estimation unit 115) will be described. The transmission line parameter estimation apparatus 100 estimates a non-linear constant of an estimation target by comparing a reference value (non-linear phase rotation amount distribution) acquired and calculated from a simulation and a measurement system illustrated in FIG. 6A with a non-linear phase rotation amount distribution of a transmission line of the estimation target illustrated in FIG. 6B.

Based on Expression (5) described above, the transmission line parameter estimation apparatus 100 estimates a non-linear constant of the transmission line 120 of an estimation target. In Expression (5) described above, the reference value includes each value of the phase rotation amount φ₁, the non-linear constant K₁, the chromatic dispersion coefficient D₁, and the fiber input power P₁. Each of the phase rotation amount φ₂, the non-linear constant K₂, the chromatic dispersion coefficient D₂, and the fiber input power P₂ of the estimation target is each value of a non-linear phase rotation amount distribution of the transmission line of the estimation target. The chromatic dispersion coefficient is estimated by the chromatic dispersion coefficient estimation unit 114. The fiber input power P₂ is acquired from monitor information.

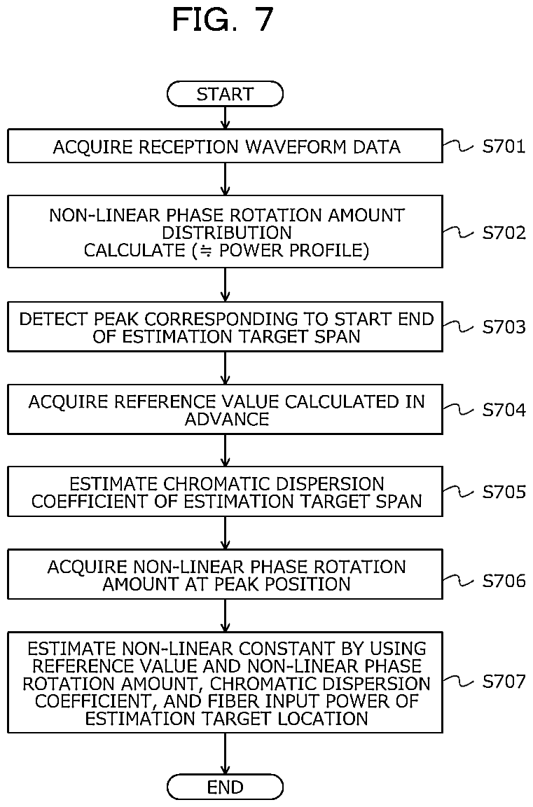

FIG. 7 is a flowchart illustrating an example of a process of estimating a non-linear constant. A process example of the transmission line parameter estimation apparatus 100 (processor 501) will be described. First, the transmission line parameter estimation apparatus 100 acquires reception waveform data of a reception signal (step S701). Next, the transmission line parameter estimation apparatus 100 calculates a non-linear phase rotation amount distribution (FIG. 6B) of the transmission line 120 which is an estimation target (step S702). The non-linear phase rotation amount distribution corresponds to a power profile of the transmission line 120.

Next, the transmission line parameter estimation apparatus 100 detects a peak corresponding to a start end of one span of the estimation target (step S703). A dotted frame in FIG. 6B is an estimation target span, and the peak p at a start end of the estimation target span is detected.

Next, the transmission line parameter estimation apparatus 100 acquires a reference value calculated in advance (step S704). Next, the transmission line parameter estimation apparatus 100 estimates an estimation target span chromatic dispersion coefficient (step S705). Details of the estimation of the estimation target span chromatic dispersion coefficient will be described below.

Next, the transmission line parameter estimation apparatus 100 acquires the non-linear phase rotation amount φ₂ at a position of the detected peak p (step S706). By using the reference value, the non-linear phase rotation amount, the chromatic dispersion coefficient, and the fiber input power of an estimation target location, the transmission line parameter estimation apparatus 100 estimates a non-linear constant of one span of the estimation target (step S707), and ends the process.

The reference value includes each value of the non-linear phase rotation amount φ₁, the non-linear constant, the chromatic dispersion coefficient, and the fiber input power illustrated in FIG. 6A. The transmission line parameter estimation apparatus 100 substitutes each value into Expression (5) described above to estimate the non-linear constant of the span of the estimation target, and outputs the estimation value.

By changing the span as the estimation target and repeatedly executing the process described above in FIG. 7, the transmission line parameter estimation apparatus 100 estimates non-linear constants of all spans of the transmission line 120.

(For Chromatic dispersion Coefficient Estimation)

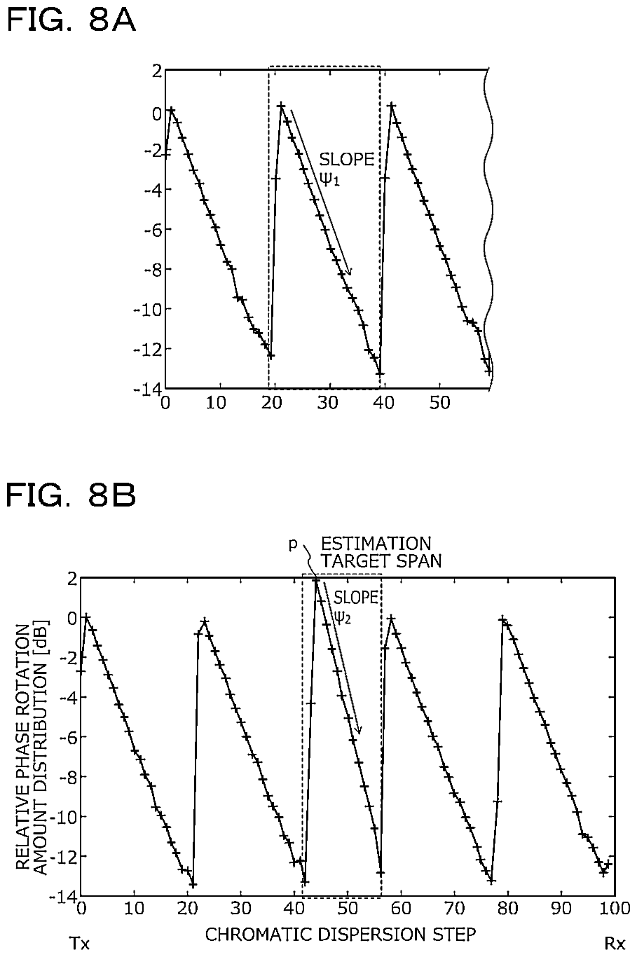

FIGS. 8A and 8B are explanatory diagrams of a process of estimating a chromatic dispersion coefficient. A process example of the transmission line parameter estimation apparatus 100 (mainly the chromatic dispersion coefficient estimation unit 114) will be described. Based on the reference value illustrated in FIG. 8A and the ratio of the slope of the non-linear phase rotation amount distribution of the estimation target illustrated in FIG. 8B (Expression (4) described above), the transmission line parameter estimation apparatus 100 estimates a chromatic dispersion coefficient of the estimation target.

In Expression (5) described above, it is assumed that a slope ψ₁ of the phase rotation amount of the reference value and the chromatic dispersion coefficient D₁, and a slope ψ₂ of the phase rotation amount obtained from the phase rotation amount distribution of the transmission line as the estimation target and the chromatic dispersion coefficient D₂ are set.

The transmission line parameter estimation apparatus 100 estimates the chromatic dispersion coefficient D₂ of the span as the estimation target by comparing the slope of the non-linear phase rotation amount distribution (dB display) with the reference value.

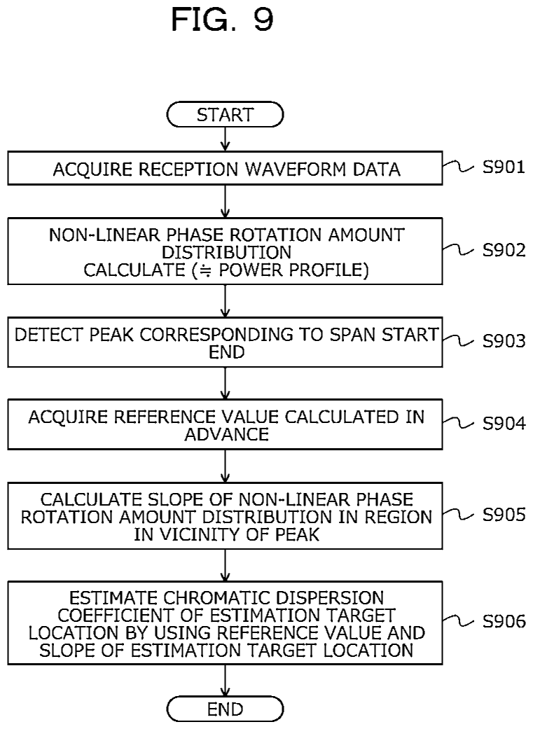

FIG. 9 is a flowchart illustrating an example of a process of estimating a chromatic dispersion coefficient. A process example of the transmission line parameter estimation apparatus 100 (processor 501) will be described. First, the transmission line parameter estimation apparatus 100 acquires reception waveform data of a reception signal (step S901). Next, the transmission line parameter estimation apparatus 100 calculates a non-linear phase rotation amount distribution (FIG. 6B) of the transmission line 120 which is an estimation target (step S902). The non-linear phase rotation amount distribution corresponds to a power profile of the transmission line 120.

Next, the transmission line parameter estimation apparatus 100 detects a peak corresponding to a start end of one span of the estimation target (step S903). A dotted frame in FIG. 8B is an estimation target span, and the peak p at a start end of the estimation target span is detected.

Next, the transmission line parameter estimation apparatus 100 acquires a reference value calculated in advance (step S904). Next, the transmission line parameter estimation apparatus 100 calculates a slope of the non-linear phase rotation amount distribution in a region in the vicinity of the peak p (step S905). For example, the slope ψ₂ of the peak p in the region of the span as the estimation target illustrated in FIG. 8B is calculated.

Next, by using the reference value and the slope of the estimation target location, the transmission line parameter estimation apparatus 100 estimates a chromatic dispersion coefficient of the estimation target location (step S906), and ends the process.

By changing the span as the estimation target and repeatedly executing the process described above in FIG. 9, the transmission line parameter estimation apparatus 100 estimates chromatic dispersion coefficients of all spans of the transmission line 120.

The processes of steps S701 to S704 in FIG. 7 have the same manner as the processes of steps S901 to S904 in FIG. 9. For example, the transmission line parameter estimation apparatus 100 may store the process results of step S701 to step S704 in FIG. 7, and may use the process results in the process of step S905 in FIG. 9.

### (Configuration Example of Calculating Reference Value In Advance)

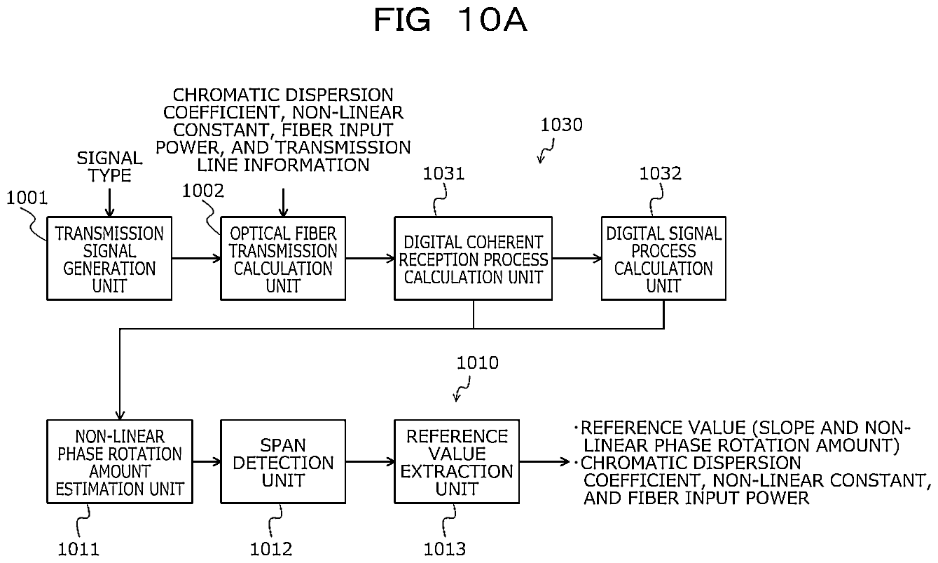

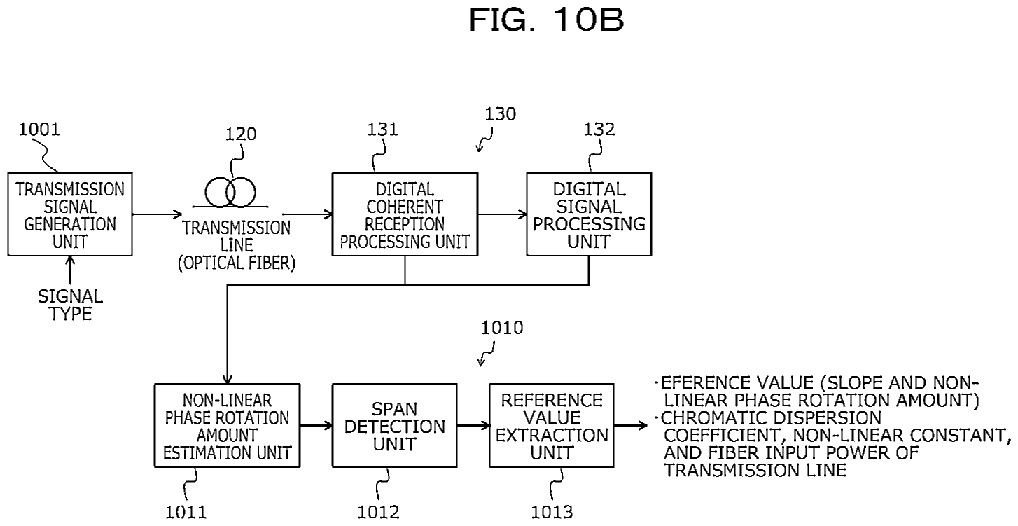

FIG. 10A and FIG. 10B are diagrams illustrating a configuration example of calculating a reference value in advance. FIG. 10A is a configuration example including a reference value calculation unit 1010 that calculates a reference value in advance by a simulation over a computer, for example. The reference value calculation unit 1010 illustrated in FIG. 10B is a configuration example in which a measurement system calculates a reference value by measuring an actual transmission line in advance.

In the configuration illustrated in FIG. 10A, each function of an optical reception unit 1030 includes a transmission signal generation unit 1001, an optical fiber transmission calculation unit 1002, a digital coherent reception process calculation unit 1031, and a digital signal process calculation unit 1032.

The transmission signal generation unit 1001 generates a transmission signal corresponding to a predetermined signal type which is input. Based on the input chromatic dispersion coefficient, non-linear constant, fiber input power, and transmission line information, the optical fiber transmission calculation unit 1002 calculates a transmission characteristic of an optical fiber. The digital coherent reception process calculation unit 1031 performs a calculation process related to digital coherent reception. The digital signal process calculation unit 1032 performs a calculation process related to a signal process of digital signal demodulation.

Each function of the reference value calculation unit 1010 includes a non-linear phase rotation amount estimation unit 1011, a span detection unit 1012, and a reference value extraction unit 1013. Functions of the reference value calculation unit 1010 (the non-linear phase rotation amount estimation unit 1011, the span detection unit 1012, and the reference value extraction unit 1013) are substantially the same as the functions of the non-linear phase rotation amount estimation unit 111, the span detection unit 112, and the reference value acquisition unit 113 illustrated in FIG. 1. A difference is that a reference value is generated by simulation execution.

Although the reference value acquisition unit acquires a reference value in FIG. 1, FIG. 10A is different from FIG. 1 in that the reference value extraction unit 1013 is provided and the reference value is extracted.

The non-linear phase rotation amount estimation unit 1011 acquires data of a result of simulation by the digital coherent reception process calculation unit 1031 or the digital signal process calculation unit 1032.

As a simulated reference value, the reference value extraction unit 1013 outputs a slope, a non-linear phase rotation amount, a chromatic dispersion coefficient, a non-linear constant, and fiber input power.

FIG. 10B is a configuration example in which a reference value is calculated in advance by a measurement system. In the configuration example illustrated in FIG. 10B, components in the same manner as the components illustrated in FIG. 1 and FIG. 10A are denoted by the same reference signs.

The optical reception unit 130 includes the digital coherent reception processing unit 131 and the digital signal processing unit 132 in the same manner as FIG. 1. The transmission signal generation unit 1001 generates a transmission signal corresponding to the predetermined signal type which is input.

In the same manner as FIG. 10A, each function of the reference value calculation unit 1010 includes the non-linear phase rotation amount estimation unit 1011, the span detection unit 1012, and the reference value extraction unit 1013.

Meanwhile, in any of the configuration examples illustrated in FIGS. 10A and 10B, each function of the reference value calculation unit 1010 has the same manner as the function of the transmission line parameter estimation apparatus 100 illustrated in FIG. 1, and a reference value may be calculated in advance by the computer process in the same manner as FIG. 1. For this reason, for example, the functions illustrated in FIG. 1 may be used for each function illustrated in FIGS. 10A and 10B. For example, components having functions in the same manner are the non-linear phase rotation amount estimation unit 1011 to the reference value extraction unit 1013. The digital coherent reception process calculation unit 1031 and the digital signal process calculation unit 1032 may be included.

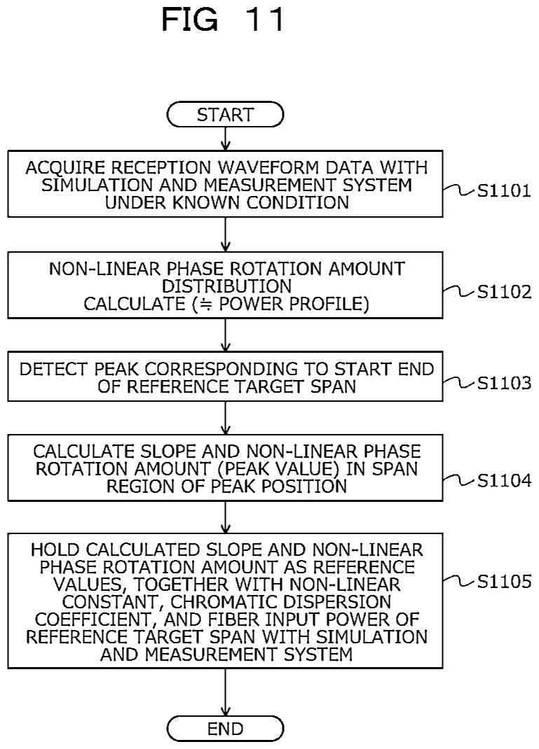

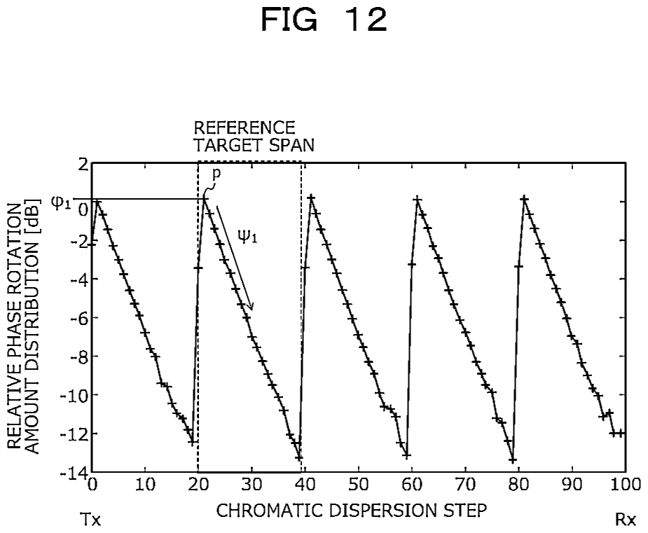

FIG. 11 is a flowchart illustrating an example of a process of calculating a reference value in advance. FIG. 12 is a chart illustrating the reference value calculated in a simulation and a measurement system. A process example of the reference value calculation unit 1010 (processor 501) in FIGS. 10A and 10B will be described.

First, the reference value calculation unit 1010 acquires reception waveform data of a reception signal in a simulation and/or a measurement system under known conditions (step S1101). Next, the reference value calculation unit 1010 calculates a non-linear phase rotation amount distribution (FIG. 12) of the simulation and/or a measurement system under the known conditions (step S1102). The non-linear phase rotation amount distribution corresponds to a power profile of the transmission line 120.

Next, the reference value calculation unit 1010 detects a peak corresponding to a start end of one span as a reference target (step S1103). For example, a dotted frame in FIG. 12 is a reference target span, and the peak p at a start end of the reference target span is detected.

Next, the reference value calculation unit 1010 calculates a slope of the non-linear phase rotation amount distribution at a peak position in a reference target span region and a peak value of a non-linear phase rotation amount (step S1104). For example, the value of the peak p and the slope ψ₁ in the region of the reference target span illustrated in FIG. 12 are calculated.

Next, the reference value calculation unit 1010 holds the calculated slope and non-linear phase rotation amount as reference values together with a non-linear constant, a chromatic dispersion coefficient, and fiber input power of the reference target span in the simulation and the measurement system (step S1105), and ends the process. The calculated reference value is stored and held in a storage unit such as the memory 502, and the reference value acquisition unit 113 (FIG. 1) reads the calculated reference value from the storage unit when a transmission line parameter as an estimation target is estimated.

### (Application Example To Construction of Transmission Line Model)

Next, an application example to transmission line model construction will be described. As an input parameter for constructing a transmission line model that simulates a transmission line as an estimation target, the transmission line parameter estimated according to the embodiment described above may be used. The transmission line model is, for example, a transmission simulation model, a transmission quality (QoT) estimation model, or the like.

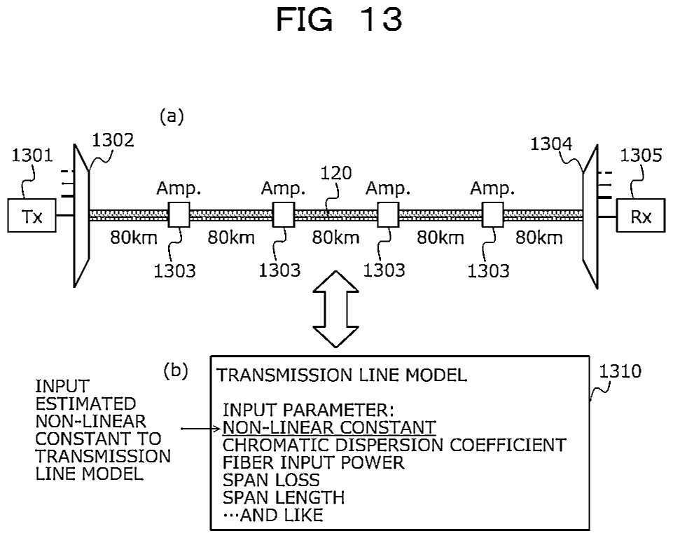

FIG. 13 are explanatory diagrams of a transmission line model. In a transmission system illustrated in FIG. 13(a), signal light of an optical transmitter (Tx) 1301 for each different wavelength is multiplexed in a MUX 1302 and transmitted, at a transmission end of the signal light. A plurality of optical amplifiers 1303 arranged at predetermined distances (for example, 80 km) corresponding to spans optically amplify the signal light, over the transmission line 120. At a reception end of the signal light, a DEMUX 1304 wavelength-demultiplexes the signal light, and an optical receiver (Rx) 1305 for each wavelength receives and processes the signal light of each wavelength.

A transmission line model 1310 illustrated in FIG. 13(b) is a model that simulates the transmission line 120, and includes a non-linear constant, a chromatic dispersion coefficient, fiber input power, a span loss, a span length, and the like as input parameters. Based on these input parameters, the transmission line model 1310 performs modeling on the transmission line 120. A non-linear constant estimated in the embodiment described above is input to the transmission line model 1310.

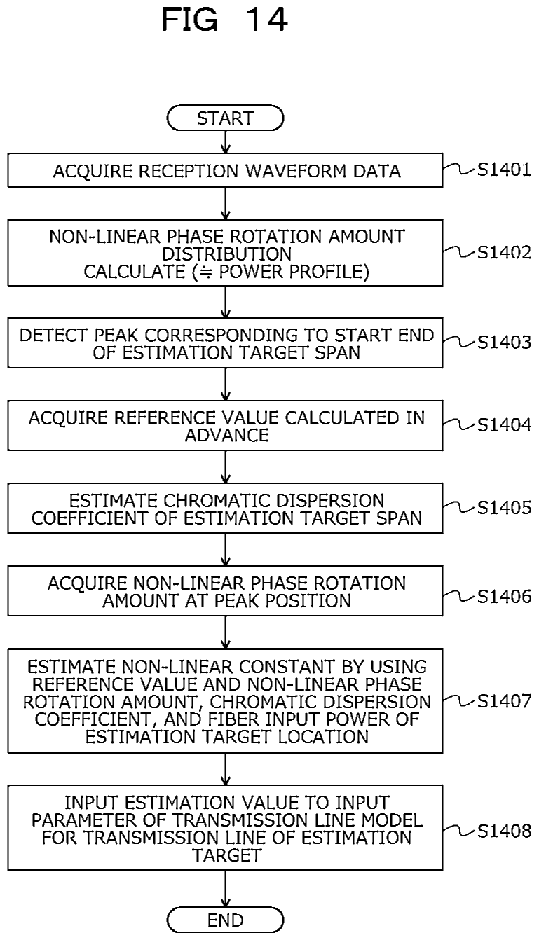

FIG. 14 is a flowchart illustrating an example of constructing a transmission line model by using an estimation value of a non-linear constant. A process example of constructing the transmission line model illustrated in FIG. 13 by the process of the transmission line parameter estimation apparatus 100 (processor 501) will be described.

Processes of steps S1401 to S1407 in FIG. 14 have the same manner as the processes of steps S701 to S707 in FIG. 7. First, the transmission line parameter estimation apparatus 100 acquires reception waveform data of a reception signal (step S1401). Next, the transmission line parameter estimation apparatus 100 calculates a non-linear phase rotation amount distribution of the transmission line 120 that is an estimation target (step S1402).

Next, the transmission line parameter estimation apparatus 100 detects a peak corresponding to a start end of one span of the estimation target (step S1403).

Next, the transmission line parameter estimation apparatus 100 acquires a reference value calculated in advance (step S1404). Next, the transmission line parameter estimation apparatus 100 estimates an estimation target span chromatic dispersion coefficient (step S1405).

Next, the transmission line parameter estimation apparatus 100 acquires a non-linear phase rotation amount at a position of the detected peak (step S1406). By using the reference value, the non-linear phase rotation amount, the chromatic dispersion coefficient, and the fiber input power of the estimation target location, the transmission line parameter estimation apparatus 100 estimates a non-linear constant of one span of the estimation target (step S1407).

At the process in step S1407, the transmission line parameter estimation apparatus 100 substitutes each value into Expression (5) described above to estimate the non-linear constant of the span of the estimation target, and outputs the estimation value.

By changing the span as the estimation target and repeatedly executing the process described above in FIG. 14, the transmission line parameter estimation apparatus 100 estimates non-linear constants of all spans of the transmission line 120.

After that, the transmission line parameter estimation apparatus 100 inputs the estimation value (non-linear constant) to an input parameter of a transmission line model related to the transmission line as the estimation target (step S1408), and ends the process. The non-linear constant has a predetermined value for each span of the transmission line 120.

Therefore, it is possible to construct the transmission line model 1310 in which an actual state of the transmission line 120 is reflected. For example, the transmission line model is a transmission simulation model, a transmission quality (QoT) estimation model, or the like, and it is possible to improve estimation accuracy of the transmission simulation, the transmission quality, or the like in the transmission line model 1310. Since the transmission line parameter estimation apparatus 100 according to the embodiment may estimate the transmission line parameter with only a single wavelength among a plurality of wavelength paths over the same route, it is possible to reduce a calculation cost and to easily estimate the transmission line parameter.

### (Application Example to Fiber Type Identification)

Next, an application example to fiber type identification will be described. By using a transmission line parameter such as an estimated non-linear constant, it is possible to identify a fiber type (fiber category) for each span of the transmission line 120.

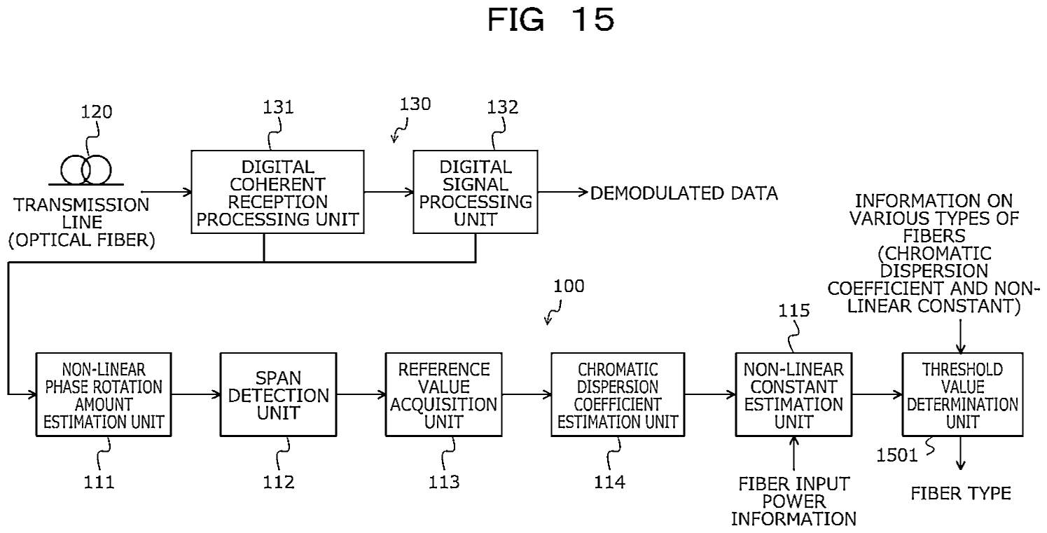

FIG. 15 is a functional block diagram illustrating an application example to fiber type identification. Among respective functions of the transmission line parameter estimation apparatus 100 illustrated in FIG. 15, the functions described with reference to FIG. 1 are denoted by the same reference signs. As a function different from the functions in FIG. 1, a threshold value determination unit 1501 is provided at a subsequent stage of the non-linear constant estimation unit 115 in FIG. 15.

Transmission line parameters (chromatic dispersion coefficient, non-linear constant, and the like) of the transmission line 120 as an estimation target estimated by the non-linear constant estimation unit 115 and information (chromatic dispersion coefficient and non-linear constant) of various types of known fibers are input to the threshold value determination unit 1501. The threshold value determination unit 1501 sets a predetermined threshold value in accordance with the information on various types of known fibers, and specifies a fiber type by comparing a transmission line parameter (chromatic dispersion coefficient, non-linear constant, or the like) of the transmission line 120 as the estimation target with the threshold value.

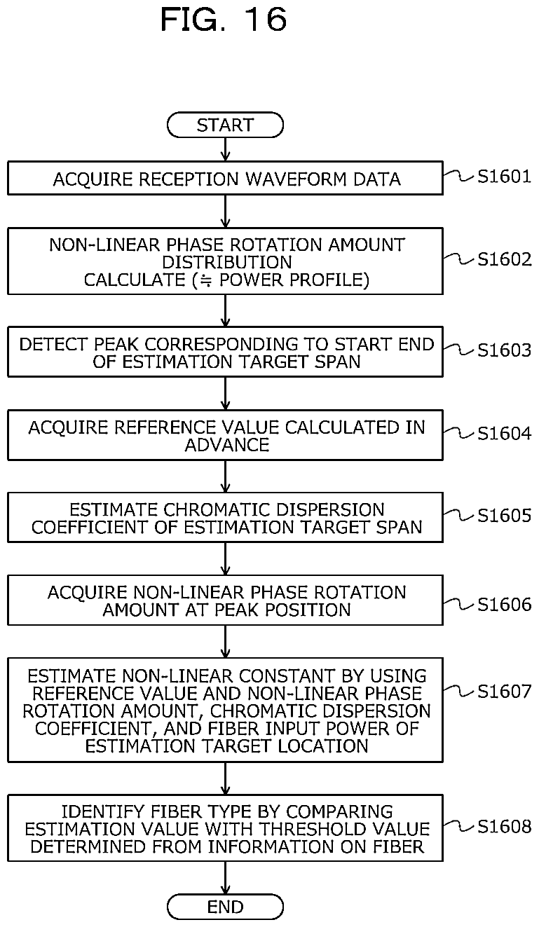

FIG. 16 is a flowchart illustrating an example of fiber type identification using an estimation value of a non-linear constant. A process example for identifying a fiber type by the process of the transmission line parameter estimation apparatus 100 (processor 501) will be described.

Processes of steps S1601 to S1607 in FIG. 16 have the same manner as the processes of steps S701 to S707 in FIG. 7. First, the transmission line parameter estimation apparatus 100 acquires reception waveform data of a reception signal (step S1601). Next, the transmission line parameter estimation apparatus 100 calculates a non-linear phase rotation amount distribution of the transmission line 120 that is an estimation target (step S1602).

Next, the transmission line parameter estimation apparatus 100 detects a peak corresponding to a start end of one span of the estimation target (step S1603).

Next, the transmission line parameter estimation apparatus 100 acquires a reference value calculated in advance (step S1604). Next, the transmission line parameter estimation apparatus 100 estimates an estimation target span chromatic dispersion coefficient (step S1605).

Next, the transmission line parameter estimation apparatus 100 acquires a non-linear phase rotation amount at a position of the detected peak (step S1606). By using the reference value, the non-linear phase rotation amount, the chromatic dispersion coefficient, and the fiber input power of the estimation target location, the transmission line parameter estimation apparatus 100 estimates a non-linear constant of one span of the estimation target (step S1607).

At the process in step S1607, the transmission line parameter estimation apparatus 100 substitutes each value into Expression (5) described above to estimate a transmission line parameter (non-linear constant and chromatic dispersion coefficient) of the span of the estimation target, and outputs the estimation value.

By changing the span as the estimation target and repeatedly executing the process described above in FIG. 16, the transmission line parameter estimation apparatus 100 estimates the transmission line parameter (non-linear constant and chromatic dispersion coefficient) of all spans of the transmission line 120.

After that, the transmission line parameter estimation apparatus 100 compares the estimation value (the non-linear constant and the chromatic dispersion coefficient non-linear constant) with a threshold value determined from information on a fiber, identifies a fiber type (step S1608), and ends the process.

Therefore, the fiber type of the transmission line 120 may be estimated. For example, the fiber type of each span described with reference to FIG. 4A may be estimated. For example, efficiency of the estimation of the fiber type of each span of the transmission line 120 may be improved. It is possible to reduce an influence of a performance deterioration such as a decrease in SNR margin due to incorrect coupling of fibers. Since the transmission line parameter estimation apparatus 100 according to the embodiment may estimate the transmission line parameter with only a single wavelength among a plurality of wavelength paths over the same route, a calculation cost may be reduced, and a fiber type may be easily identified.

### Application Example of Identifying Fiber Type By Using Known Fiber Type Information as Reference Value

In this application example, an estimated physical quantity is used to identify a type of fiber installed in the transmission line 120. Meanwhile, as a reference value, information on a span having an identifiable fiber type by an existing method or the like is used.

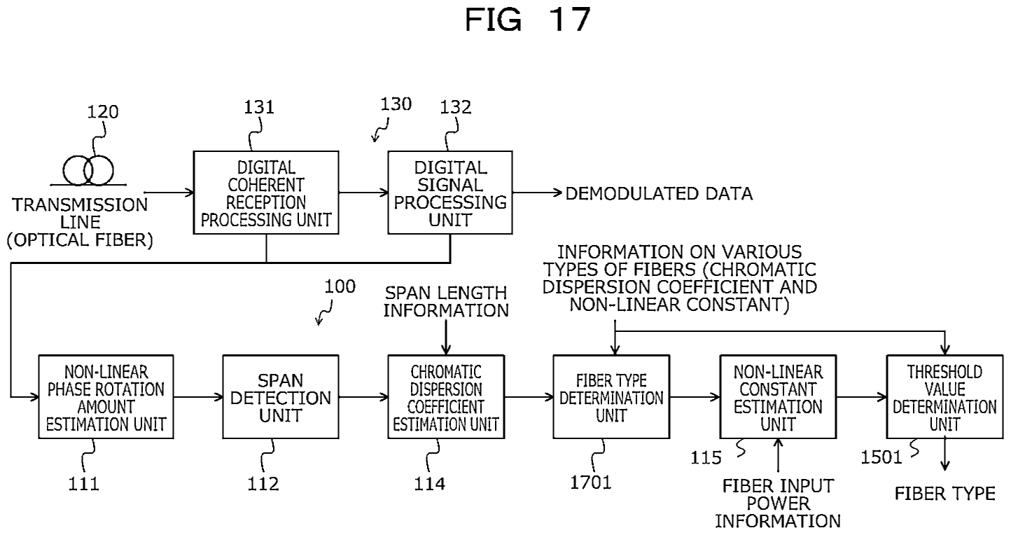

FIG. 17 is a functional block diagram illustrating another application example to the fiber type identification. Among respective functions of the transmission line parameter estimation apparatus 100 illustrated in FIG. 17, the functions described with reference to FIG. 15 are denoted by the same reference signs. As a function different from the functions in FIG. 15, the reference value acquisition unit 113 in FIG. 15 is not provided in FIG. 17. A fiber type determination unit 1701 is provided between a subsequent stage of the chromatic dispersion coefficient estimation unit 114 and the non-linear constant estimation unit 115.

A span length (fiber length) information is input to the chromatic dispersion coefficient estimation unit 114 in FIG. 17. The chromatic dispersion coefficient estimation unit 114 estimates a chromatic dispersion coefficient of a span from data of the span length and a chromatic dispersion amount between peaks.

The chromatic dispersion coefficient estimated by the chromatic dispersion coefficient estimation unit 114 and information (chromatic dispersion coefficient and non-linear constant) of various types of fibers are input to the fiber type determination unit 1701 and the threshold value determination unit 1501. The fiber type determination unit 1701 specifies a fiber type from the estimated chromatic dispersion coefficient of the span, and holds the specified fiber type of span and physical characteristics of the fiber as reference values in a storage unit such as the memory 502. The fiber type determination unit 1701 acquires the span of which the fiber type is specified and the non-linear phase rotation amount of the peak position of the estimation target location of the transmission line 120.

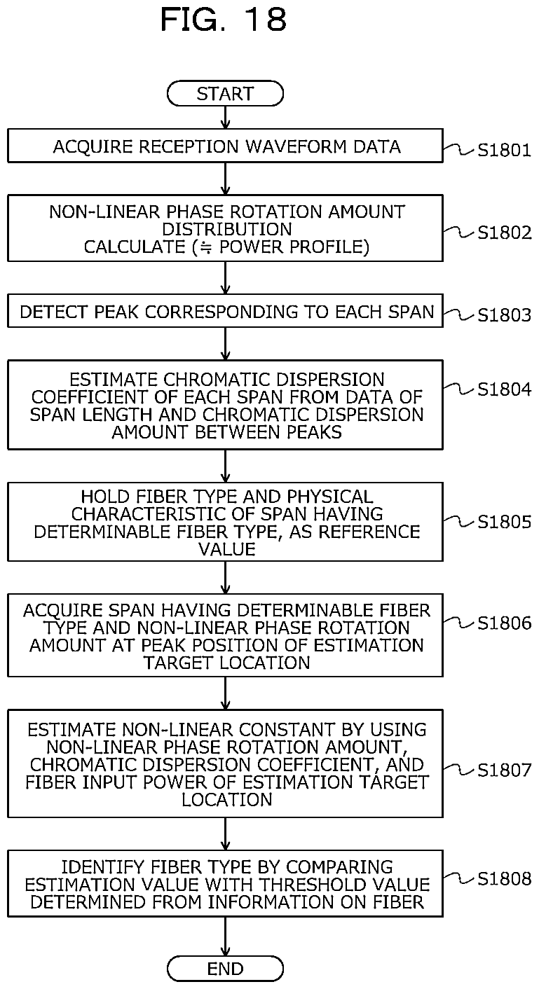

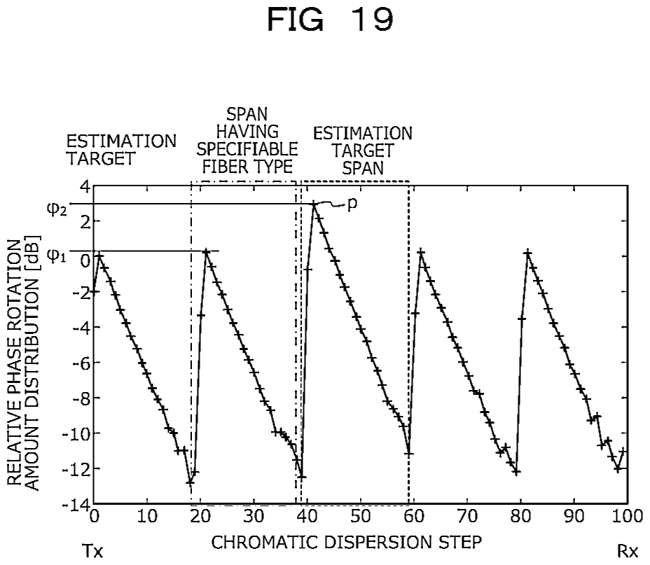

FIG. 18 is a flowchart illustrating an example of a process of fiber type identification. FIG. 19 is a chart illustrating a phase rotation amount distribution of an estimation target. A process example for identifying a fiber type by the process of the transmission line parameter estimation apparatus 100 (processor 501) will be described.

First, the transmission line parameter estimation apparatus 100 acquires reception waveform data of a reception signal (step S1801). Next, the transmission line parameter estimation apparatus 100 calculates a non-linear phase rotation amount distribution of the transmission line 120 that is an estimation target (step S1802).

Next, the transmission line parameter estimation apparatus 100 detects a peak corresponding to a start end of each span of the estimation target (step S1803).

Next, the transmission line parameter estimation apparatus 100 estimates a chromatic dispersion coefficient of each span, from data of a span length and a chromatic dispersion amount between peaks (step S1804). Next, the transmission line parameter estimation apparatus 100 holds, as reference values, a fiber type and physical characteristics of the span having the determinable fiber type illustrated in FIG. 19 (step S1805).

Next, the transmission line parameter estimation apparatus 100 acquires the span having the determinable fiber type and the non-linear phase rotation amounts φ₁ and φ₂ at a position of the peak p at an estimation target location (step S1806).

Next, the transmission line parameter estimation apparatus 100 estimates a non-linear constant of one span as the estimation target by using the non-linear phase rotation amount, the chromatic dispersion coefficient, and fiber input power of the estimation target location (step S1807).

At the process in step S1807, the transmission line parameter estimation apparatus 100 substitutes each value into Expression (5) described above to estimate a transmission line parameter (non-linear constant and chromatic dispersion coefficient) of the span of the estimation target, and outputs the estimation value.

After that, the transmission line parameter estimation apparatus 100 compares the estimation value (the non-linear constant and the chromatic dispersion coefficient non-linear constant) with a threshold value determined from information on a fiber, and identifies a fiber type (step S1808).

By changing the span as the estimation target and repeatedly executing the process described above in FIG. 18, the transmission line parameter estimation apparatus 100 estimates the transmission line parameter (non-linear constant and chromatic dispersion coefficient) of all spans of the transmission line 120.

In this manner, the fiber type of the span as the estimation target may also be estimated by using the information on the span of the fiber type that may be already identified among a plurality of spans of the transmission line 120.

### Specific Example of Fiber Type According to Existing Technology

Next, a specific example of a fiber type according to an existing technology and a problem thereof will be described. As the existing technology, a technology for estimating a chromatic dispersion coefficient by using a power profile estimation (correlation method)) is disclosed (see, for example, Japanese Laid-open Patent Publication No. 2018-133725 and U.S. Patent Application Publication No. 2018/0234184).

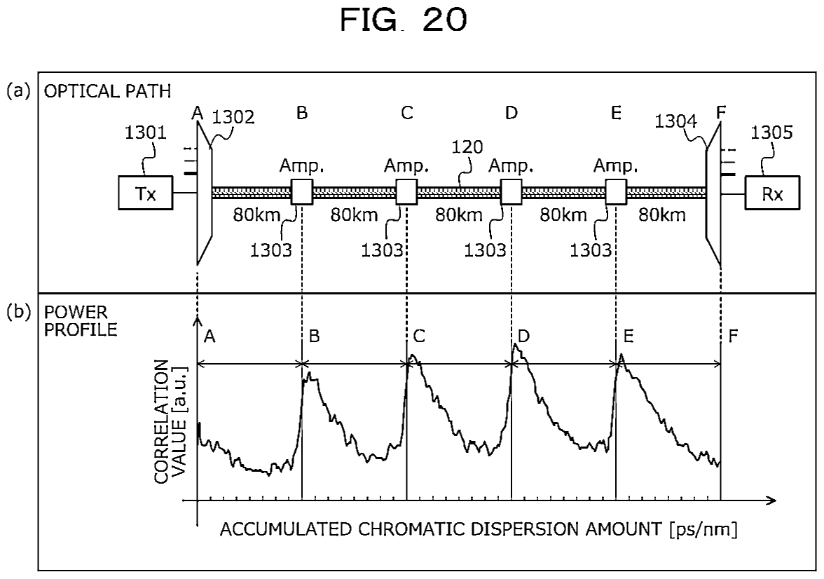

FIG. 20 are explanatory diagrams of estimation of a chromatic dispersion coefficient by using existing power profile estimation. FIG. 20(a) illustrates an optical path, in which the optical transmitter (Tx) 1301, the MUX 1302, the plurality of optical amplifiers 1303, the DEMUX 1304, and the optical receiver (Rx) 1305 for each wavelength are arranged in the same manner as illustrated in FIG. 13. FIG. 20(b) is a power profile of the optical path illustrated in FIG. 20(a), in which a horizontal axis indicates an accumulated chromatic dispersion amount and a vertical axis indicates a correlation value.

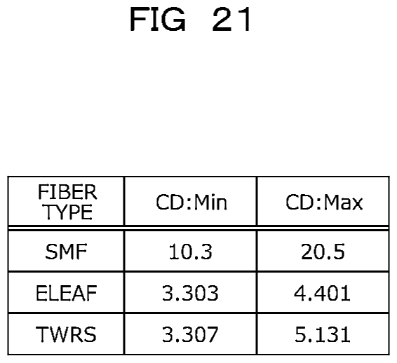

FIG. 21 is a chart illustrating an example of a fiber specification. Chromatic dispersion coefficients (CDs) of SMF, ELEAF, and TWRS are indicated as fiber types.

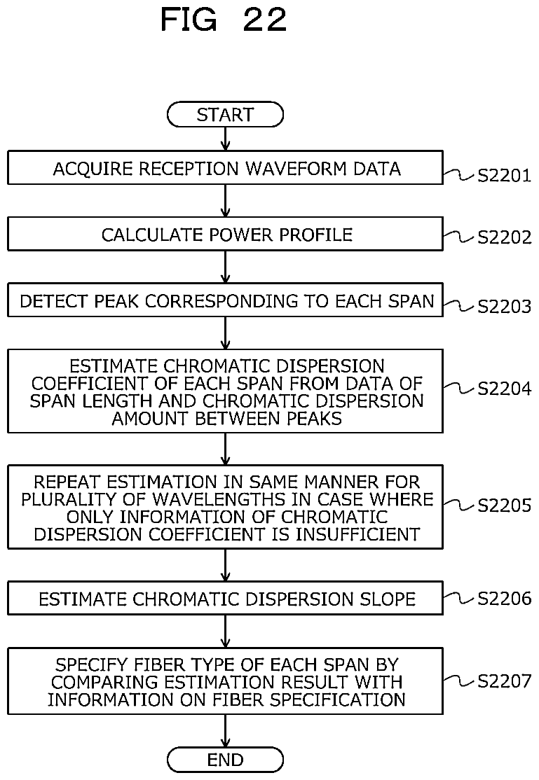

FIG. 22 is a flowchart illustrating an example of specifying a fiber type by using existing power profile estimation. A process example in which the optical receiver (Rx) 1305 at the reception end illustrated in FIG. 20(a) estimates a chromatic dispersion coefficient by using power profile estimation and specifies a fiber type will be described.

First, reception waveform data of a reception signal is acquired (step S2201). Next, a power profile of the transmission line 120 is calculated (step S2202 in FIG. 20(b)). Next, a peak corresponding to each span is detected (step S2203).

Next, a chromatic dispersion coefficient of each span is estimated from data of a span length and a chromatic dispersion amount between peaks (step S2204). In a case where only information on the chromatic dispersion coefficient is insufficient for the estimation of the chromatic dispersion coefficient, the same estimation is repeated for a plurality of wavelengths (step S2205).

Next, a chromatic dispersion slope is estimated (step S2206). By comparing an estimation result with the information on the fiber specification (FIG. 21), a fiber type of each span is specified (step S2207), and the process is ended.

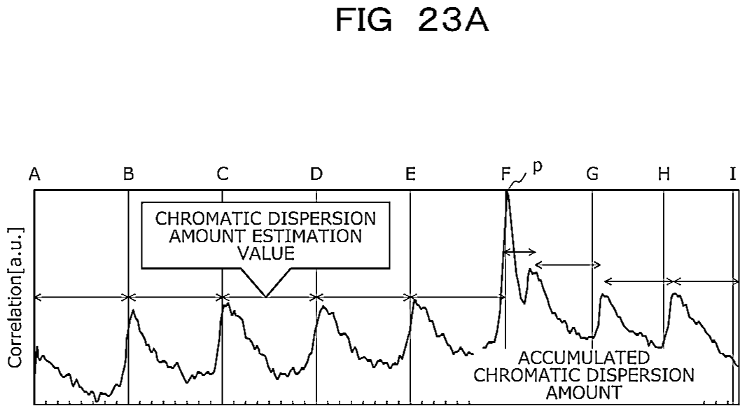

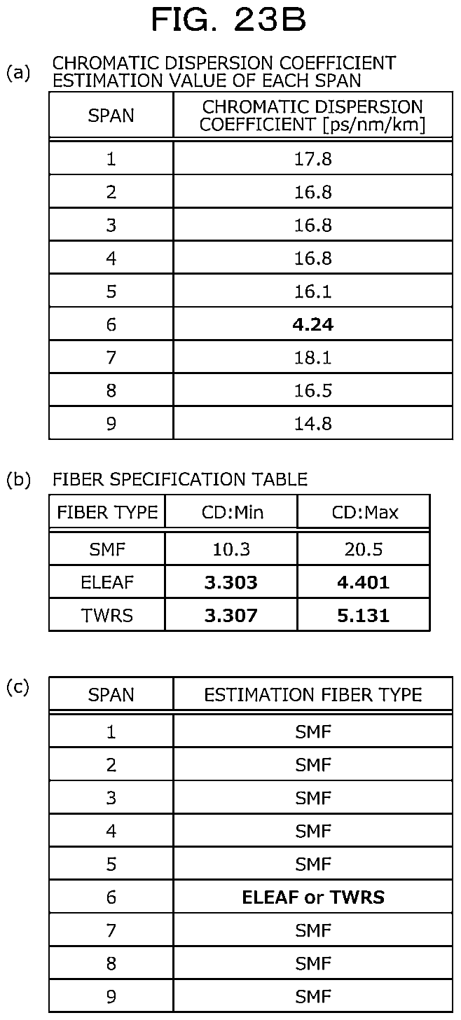

FIG. 23A is a chart illustrating an example of a power profile of an optical path based on existing power profile estimation. FIG. 23B is a chart illustrating various types of data used to specify a fiber type by using the existing power profile estimation.

A chromatic dispersion amount between peaks of each span is obtained by the power profile estimation illustrated in FIG. 22, and a chromatic dispersion coefficient of each span illustrated in (a) of 23B is obtained. A section A-B illustrated in FIG. 23A corresponds to a span 1 in (a) of FIG. 23B. In the same manner, a section B-C illustrated in FIG. 23A corresponds to a span 2 in (a) of FIG. 23B.

In FIG. 23B, (b) is a chart illustrating a fiber specification in the same manner as FIG. 21, and in FIG. 23B, (c) is a chart illustrating an estimation fiber type for each span.

In a power profile illustrated in FIG. 23A, the peak p of an accumulated chromatic dispersion amount (correlation value) at a start end of a section F-G is higher than the other sections, and a value (4.24) of the chromatic dispersion coefficient of a span 6 illustrated in (a) of FIG. 23B is correspondingly lower than the other sections.

It is assumed that the estimated value (4.24) of the chromatic dispersion coefficient of the span 6 is used and compared with the fiber specification table in (b) of FIG. 23B. In this case, as illustrated in (c) of FIG. 23B, it is not possible to determine whether a fiber type of the span 6 is ELEAF (CD: 3.303 to 4.401) or TWRS (CD: 3.307 to 5.131).

In this manner, there is a case where the fiber type may not be specified only by the result of estimating the chromatic dispersion coefficient by using the power profile estimation of the existing technology. In this case, in the existing technology, it is desirable to calculate a power profile at each of a plurality of different wavelengths for the transmission line 120 and obtain a chromatic dispersion slope. Therefore, in the existing technology, 1. a calculation cost for the number of wavelengths is desirable, and 2. data of a plurality of wavelengths is desirable and the existing technology is limited to a case where the data of the plurality of wavelengths may be acquired.

### (For Fiber Type Identification Function)

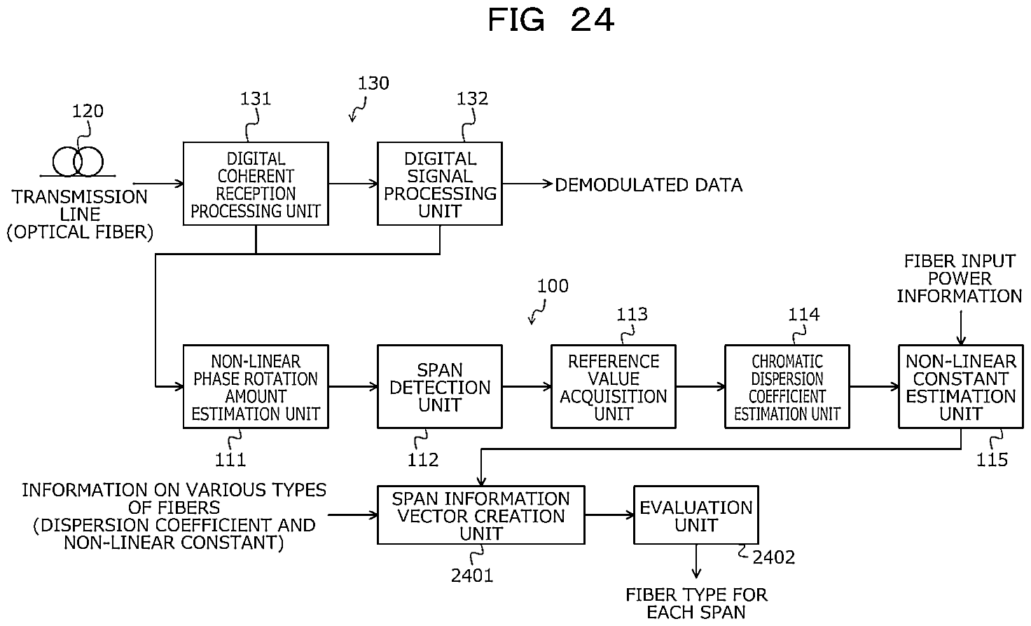

FIG. 24 is a functional block diagram illustrating identification of a fiber type by a transmission line parameter estimation apparatus according to the embodiment. In FIG. 24, components in the same manner as the components illustrated in FIG. 1 are indicated by the same reference signs. As illustrated in FIG. 24, as a function of identifying a fiber type, a span information vector creation unit 2401 and an evaluation unit 2402 are provided at a subsequent stage of the non-linear constant estimation unit 115.

The span information vector creation unit 2401 receives a non-linear constant of each span estimated by the non-linear constant estimation unit 115 and information (chromatic dispersion coefficient and non-linear constant) on various types of fibers, and creates a span information vector in which the chromatic dispersion coefficients and the non-linear constants of a plurality of spans are arranged. The span information vector includes a chromatic dispersion coefficient V_cd and a non-linear constant V_nl. It is assumed that candidates for the fiber type in each span are known in advance. The span information vector creation unit 2401 reduces the number of combination patterns by extracting only a span having an unspecified fiber type. For example, a span that may not be estimated by the existing technology is extracted.

The evaluation unit 2402 determines a vector in each arrangement pattern based on data of fiber specifications, and calculates a distance to the estimated vector as an evaluation value. For example, the evaluation unit 2402 obtains a sum of the Euclidean distance of the chromatic dispersion coefficient and the Euclidean distance of the non-linear constant, and sets the sum as the evaluation value. Among the evaluation values obtained for the respective patterns, the evaluation unit 2402 specifies a fiber type indicated by the pattern having the smallest evaluation value.

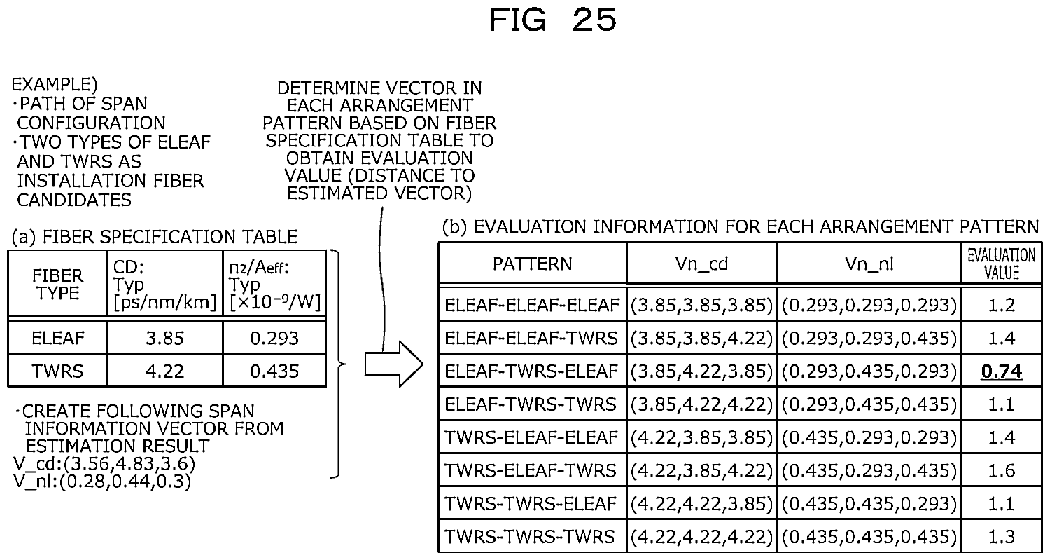

FIG. 25 are charts illustrating various types of data used for fiber type identification. FIG. 25(a) is a fiber specification table, and FIG. 25(b) is a chart illustrating evaluation information (chromatic dispersion coefficient, non-linear constant, and calculated evaluation value) for each arrangement pattern. In the example illustrated in FIG. 25(b), a pattern indicates a combination of two fiber types (ELEAF and TWRS) in three spans, a chromatic dispersion coefficient indicates a chromatic dispersion coefficient of each span of the three spans, and a non-linear constant indicates a non-linear constant of each span of the three spans.

For example, as illustrated in FIG. 25, a case where two types of ELEAF and TWRS are candidates for an installation fiber in a path having a configuration of the three spans will be described as an example. In this case, the span information vector creation unit 2401 creates span information vectors of V_cd (3.56, 4.83, 3.6) and V_nl (0.28, 0.44, 0.3) as span information vectors from the estimation result.

The evaluation unit 2402 determines a vector in each arrangement pattern based on data of fiber specifications, and obtains an evaluation value (a distance to the estimated vector). Among the evaluation values obtained for the respective patterns, the evaluation unit 2402 specifies a pattern having a minimum evaluation value, and specifies a fiber type. In the example illustrated in FIG. 25, the minimum evaluation value is 0.74, and the fiber type is specified to be ELEAF-TWRS-ELEAF from the corresponding pattern having the configuration of the three span.

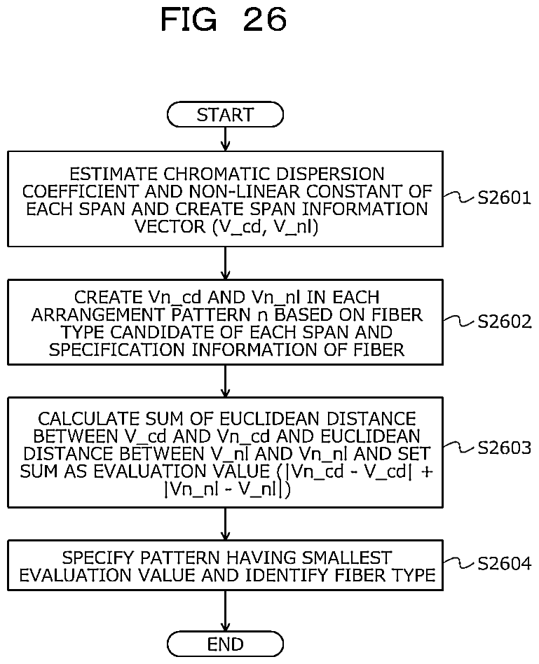

FIG. 26 is a flowchart illustrating an example of a process of identifying a fiber type of a plurality of spans according to the embodiment. A process example of identifying the fiber type of the plurality of spans by the process of the transmission line parameter estimation apparatus 100 (processor 501) illustrated in FIG. 24 will be described.

First, the transmission line parameter estimation apparatus 100 estimates a chromatic dispersion coefficient and a non-linear constant of each span by the process (for example, see FIG. 7) described in the embodiment described above, and creates a span information vector (V_cd, V_nl) (step S2601).

Next, based on a fiber type candidate of each span and specification information of a fiber, the transmission line parameter estimation apparatus 100 creates a span information vector (Vn_cd, Vn_nl) in each arrangement pattern n (step S2602).

Next, the transmission line parameter estimation apparatus 100 calculates a sum of the Euclidean distances between V_cd and Vn_cd of the span information vector and the Euclidean distances between V_nl and Vn_nl of the span information vector, and sets the sum as an evaluation value (step S2603). For example, (|Vn_cd−V_cd|+|Vn_nl−V_nl|) is calculated.

Next, the transmission line parameter estimation apparatus 100 specifies a pattern having the smallest evaluation value, identifies a fiber type (step S2604), and ends the above process.

As described above, in the embodiment, by narrowing down the fiber types based on the non-linear constant estimated from one wavelength path, it is possible to identify each fiber type of a plurality of spans without obtaining a dispersion slope. In this manner, in the embodiment, the number of wavelengths desirable for estimating the fiber type in each span of the transmission line may be reduced, and the calculation cost may be reduced. According to the embodiment, for example, it is possible to improve efficiency of estimation of the type of installation fibers in each span of the transmission line. It is possible to reduce an influence of a performance deterioration such as a decrease in SNR margin due to incorrect coupling of fibers.

A transmission line parameter estimation apparatus according to the embodiment described above includes a storage unit that stores in advance a non-linear phase rotation amount distribution obtained by using time waveform data acquired from a receiver of a first transmission line and a non-linear phase rotation amount in a second transmission line different from the first transmission line, and a control unit that refers to the data in the storage unit and obtains a non-linear constant of each span of the second transmission line based on the distribution of the non-linear phase rotation amount. Therefore, based on a reception signal at a reception end of the transmission line, it is possible to estimate a transmission line parameter of each span in a multi-span transmission system, for example, a chromatic dispersion coefficient and a non-linear constant. In the multi-span transmission system, it is possible to estimate the transmission line parameter of each span of a plurality of spans easily only by the reception end of the transmission line without adding a new optical component or device such as an optical spectrum analyzer.

For example, with the transmission line parameter estimation apparatus according to the embodiment, in a case where the first transmission line has a known transmission line parameter, the control unit may store the non-linear phase rotation amount distribution calculated by using the time waveform data of the known transmission line parameter in the storage unit, and may obtain an unknown non-linear constant of the second transmission line by referring to the data in the storage unit. The control unit may collect signal intensity information of digital coherent light transmitted through the second transmission line, and may estimate the non-linear constant of each span of the second transmission line based on the collected signal intensity information and the data stored in the storage unit. The control unit may include a reference value calculation unit that calculates the non-linear phase rotation amount distribution based on a known transmission condition with a transmission simulation or a measurement system.

The transmission line parameter estimation apparatus according to the embodiment may store a first chromatic dispersion coefficient, a first non-linear constant, input power at a first fiber input unit, and a first non-linear phase rotation amount at the first fiber input unit of the known first transmission line, in the storage unit in advance. The control unit may include a non-linear phase rotation amount estimation unit that estimates a non-linear phase rotation amount distribution at each point of the second transmission line as a function of an accumulated chromatic dispersion amount from a transmission end based on the signal intensity information of the signal light collected by an optical reception unit of the digital coherent light transmitted through the second transmission line different from the first transmission line, a span detection unit that detects a chromatic dispersion amount of each span based on the non-linear phase rotation amount distribution, a chromatic dispersion coefficient estimation unit that calculates a second chromatic dispersion coefficient of each span from information on a fiber length of each span and the chromatic dispersion amount of each span, a detection unit that detects a non-linear phase rotation amount at a second fiber input unit of each span, and a non-linear constant estimation unit that calculates a non-linear constant of each span of the second transmission line based on the first chromatic dispersion coefficient, the first non-linear constant, the input power by the first fiber input unit, the first non-linear phase rotation amount by the first fiber input unit, the second chromatic dispersion coefficient, the non-linear phase rotation amount by the second fiber input unit, and information on fiber input power of each span. In this case, for example, the information on the fiber length of each span may be acquired from design information of the transmission line by an operation input of an administrator. In this manner, it is possible to easily estimate the transmission line parameter of the estimation target span by calculating each parameter of a reference value in advance based on the known transmission condition stored in the storage unit and referring to the parameter by the control unit.

The transmission line parameter estimation apparatus according to the embodiment may store the first non-linear constant, the input power at the first fiber input unit, the first non-linear phase rotation amount at the first fiber input unit, and a slope of the first non-linear phase rotation amount with respect to the chromatic dispersion amount of the known first transmission line, in the storage unit in advance. The control unit may include the non-linear phase rotation amount estimation unit that estimates the non-linear phase rotation amount distribution at each point of the second transmission line as a function of the accumulated chromatic dispersion amount from the transmission end based on the signal intensity information of the signal light collected by the optical reception unit of the digital coherent light transmitted through the second transmission line different from the first transmission line, a detection unit that detects a non-linear phase rotation amount at the second fiber input unit of each span, a calculation unit that calculates a slope of a second non-linear phase rotation amount with respect to the chromatic dispersion amount of each span, and a non-linear constant estimation unit that calculates a non-linear constant of each span of the second transmission line based on the first non-linear constant, the input power at the first fiber input unit, the first non-linear phase rotation amount at the first fiber input unit, the slope of the first non-linear phase rotation amount, the non-linear phase rotation amount at the second fiber input unit, the slope of the second non-linear phase rotation amount, and the information on the fiber input power of each span. In this manner, it is possible to easily estimate the transmission line parameter of the estimation target span by calculating each parameter of a reference value in advance based on the known transmission condition stored in the storage unit and referring to the parameter by the control unit.

In the transmission line parameter estimation apparatus according to the embodiment, the control unit may output the estimated non-linear constant as an input parameter of a transmission line model that simulates the second transmission line. Therefore, it is possible to construct a transmission line model in which an actual state of the transmission line is reflected, and to improve estimation accuracy in a transmission simulation, QoT estimation, and the like.

In the transmission line parameter estimation apparatus according to the embodiment, the control unit may include a threshold value determination unit that compares the estimated non-linear constant with a threshold value determined in advance based on fiber information for each fiber type of the second transmission line, and identifies a fiber type of the estimation target span. Therefore, it is possible to easily identify the fiber type of the estimation target span. For example, in fiber type specification based on power profile estimation in the existing technology, a fiber type may not be specified over the existing fiber specifications only with a calculated chromatic dispersion coefficient, and signal light of a plurality of wavelengths has to be transmitted to a transmission line to calculate a power profile, which leads to an increase in calculation cost and complexity. Meanwhile, according to the embodiment, the fiber type of each span of the transmission line may be estimated with one wavelength, the number of wavelengths may be reduced, and the calculation cost may be reduced. Accordingly, it is possible to improve efficiency of the estimation of the type of installation fiber of each span of the transmission line. It is possible to reduce an influence of a performance deterioration such as a decrease in SNR margin due to incorrect coupling of fibers.

In the transmission line parameter estimation apparatus according to the embodiment, the control unit may include a fiber type determination unit that calculates, in a case where there is a span having a specifiable fiber type among a plurality of spans of the second transmission line, a fiber type and a non-linear constant of the span. In this manner, the reference value is not limited to be calculated, and in a case where there is a span having a specifiable fiber type among the plurality of spans of the transmission line, information on the fiber type of the span may be used.

In the transmission line parameter estimation apparatus according to the embodiment, the control unit may include a span information vector creation unit that creates a span information vector in which the estimated chromatic dispersion coefficient and the non-linear constant of each span are arranged for all the spans, and an evaluation unit that identifies a combination of fiber types of each span based on a distance over a vector between the chromatic dispersion coefficient and the non-linear constant of the fiber type narrowed down as a candidate in advance. Therefore, it is possible to identify the fiber type of each span from a pattern of the chromatic dispersion coefficient and the non-linear constant for each combination of the fiber types of the plurality of spans.

In the transmission line parameter estimation apparatus according to the embodiment, the span information vector creation unit may extract a span of which a fiber type is not specified, and may create a span information vector. Therefore, the identification process may be easily performed by reducing the number of combination patterns by using the fiber type of each span of the plurality of spans.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission line parameter estimation apparatus comprising:
a storage unit configured to stores in advance a non-linear phase rotation amount distribution obtained by using time waveform data acquired from a receiver, of a first transmission line, and a non-linear phase rotation amount of a second transmission line different from the first transmission line; and
a controller configured to refer to data in the storage unit and obtain a non-linear constant of each span of the second transmission line based on a distribution of the non-linear phase rotation amount.

2. The transmission line parameter estimation apparatus according to claim 1, wherein
the first transmission line has a known transmission line parameter, and
the controller stores the non-linear phase rotation amount distribution calculated by using the time waveform data of the known transmission line parameter in the storage unit, and refers to the data in the storage unit, and obtains an unknown non-linear constant of the second transmission line.

3. The transmission line parameter estimation apparatus according to claim 1, wherein
the controller collects signal intensity information of digital coherent light transmitted through the second transmission line and estimates the non-linear constant of each span of the second transmission line based on the collected signal intensity information and the data stored in the storage unit.

4. The transmission line parameter estimation apparatus according to claim 1, wherein
the controller includes a reference value calculation unit that calculates the non-linear phase rotation amount distribution based on a known transmission condition with a transmission simulation or a measurement system.

5. The transmission line parameter estimation apparatus according to claim 1, wherein
the storage unit stores in advance a first chromatic dispersion coefficient, a first non-linear constant, input power at a first fiber input unit, and a first non-linear phase rotation amount at the first fiber input unit of the known first transmission line, and
the controller includes:
a non-linear phase rotation amount estimation unit that estimates a non-linear phase rotation amount distribution at each point of the second transmission line as a function of an accumulated chromatic dispersion amount from a transmission end, based on signal intensity information of signal light collected by an optical reception unit of digital coherent light transmitted through the second transmission line different from the first transmission line,
a span detection unit that detects a chromatic dispersion amount of each span based on the non-linear phase rotation amount distribution,
a chromatic dispersion coefficient estimation unit that calculates a second chromatic dispersion coefficient of each span, from information on a fiber length of each span and the chromatic dispersion amount of each span,
a detection unit that detects a non-linear phase rotation amount at a second fiber input unit of each span, and
a non-linear constant estimation unit calculates the non-linear constant of each span of the second transmission line based on the first chromatic dispersion coefficient, the first non-linear constant, the input power at the first fiber input unit, the first non-linear phase rotation amount at the first fiber input unit, the second chromatic dispersion coefficient, the non-linear phase rotation amount at the second fiber input unit, and information on fiber input power of each span.

6. The transmission line parameter estimation apparatus according to claim 5, wherein
the controller acquires the information on the fiber length of each span from design information of the transmission line.

7. The transmission line parameter estimation apparatus according to claim 1, wherein
the storage unit stores in advance a first non-linear constant, input power at a first fiber input unit, a first non-linear phase rotation amount at the first fiber input unit, and a slope of the first non-linear phase rotation amount with respect to a chromatic dispersion amount of the known first transmission line, and
the controller includes:
a non-linear phase rotation amount estimation unit that estimates a non-linear phase rotation amount distribution at each point of the second transmission line as a function of an accumulated chromatic dispersion amount from a transmission end, based on signal intensity information of signal light collected by an optical reception unit of digital coherent light transmitted through the second transmission line different from the first transmission line,
a detection unit that detects a non-linear phase rotation amount at a second fiber input unit of each span,
a calculation unit that calculates a slope of a second non-linear phase rotation amount with respect to a chromatic dispersion amount of each span, and
a non-linear constant estimation unit calculates the non-linear constant of each span of the second transmission line based on the first non-linear constant, the input power at the first fiber input unit, the first non-linear phase rotation amount at the first fiber input unit, the slope of the first non-linear phase rotation amount, the non-linear phase rotation amount at the second fiber input unit, the slope of the second non-linear phase rotation amount, and information on fiber input power of each span.

8. The transmission line parameter estimation apparatus according to claim 1, wherein
the controller outputs an estimated non-linear constant as an input parameter of a transmission line model that simulates the second transmission line.

9. The transmission line parameter estimation apparatus according to claim 1, wherein
the controller includes a threshold value determination unit that compares an estimated non-linear constant with a threshold value determined in advance based on fiber information for each fiber type of the second transmission line and identifies a fiber type of an estimation target span.

10. The transmission line parameter estimation apparatus according to claim 1,
wherein the controller includes a fiber type determination unit that calculates, in a case where there is a span with a specifiable fiber type among a plurality of spans of the second transmission line, a fiber type and a non-linear constant of the span.

11. The transmission line parameter estimation apparatus according to claim 1,
wherein the controller includes:
a span information vector creation unit creates a span information vector in which an estimated chromatic dispersion coefficient and an estimated non-linear constant of each span are arranged for all spans, and
an evaluation unit identifies a combination of fiber types of each span based on a distance over a vector between a chromatic dispersion coefficient and a non-linear constant of a fiber type narrowed down as a candidate in advance.

12. A transmission line parameter estimation method comprising:
storing in advance a non-linear phase rotation amount distribution obtained by using time waveform data acquired from a receiver, of a first transmission line, and a non-linear phase rotation amount of a second transmission line different from the first transmission line;
referring to data in the storage unit; and
obtaining a non-linear constant of each span of the second transmission line based on a distribution of the non-linear phase rotation amount.
